(19) United States
(12) Patent Application Publication
(10) Pub. No.: US 2011/0262883 A1
(43) Pub. Date: Oct. 27, 2011

(54) Fixture mount-abutments, ball impression screw and fixture mount-abutment drivers

(76) Inventor: William Y.S. Hung, Claremont, CA (US)

(21) Appl. No.: 12/764,951

(22) Filed: Apr. 22, 2010

(51) Int. Cl. A61C 8/00

(52) U.S. Cl. 433/174

(57) ABSTRACT

A dental implant fixture mount-abutment, comprising a fixture mount is a 2 to 4 mm coronal extension/metal collar at a coronal end for serving as an impression coping, temporary/permanent abutment and fixture mount, wherein the internal slots in said coronal end for receiving the fixture mount driver, wherein the driven channel in said coronal end for receiving a ball impression screw, wherein said the fixture mount has two small flat facets, located on opposite sides of the fixture mount, extended between said coronal end and circumferential groove, an abutment which is a taper cylinder body having a shoulder and a circumferential curvature, wherein the shoulder on the abutment portion is a part of the abutment, wherein the circumferential curvature is designed to avoid engaging alveolar bone so as to be easily removed later, wherein said the abutment has two large flat facets, located on opposite sides of the abutment, extended between said circumferential groove and shoulder, providing an anti-rotation feature, wherein the ferro is an circumferentially inclined surface to engage the circumferential bevel of a dental implant, increasing the stabilization between DIFMA and dental implant, wherein the 6 wave-shaped protruding features at the coronal portion of the hex-shaped root to provide additional retention, wherein the hex-shaped root of the DIFMA is a male connector for internally connecting to a dental implant. A long DIMFA is an alternative version which contains an extension portion adjacent to the fixture mount; wherein it has a circumferential indentation, two flat surfaces and two semi-circular surfaces. Both two flat surfaces and two semi-circular surfaces are located at opposite sides of the extension portion.

A dental implant ball impression screw, comprising a bolt which is a cylinder body having an apical end, wherein the apical end of the bolt is designed to insert through a DIFMA into a dental implant, the bolt and the dental implant have a metal to metal contact which is very stable, and a shank which is a cylinder body having a coronal head, wherein the coronal head of the shank comprises a large hemisphere, a circumferential notch, a small hemisphere head and a hexagonal concavity.

A wide latch type fixture mount driver, comprising a shank which is a cylinder body having a latch type end, a body which has a upper hexagonal body and a round lower body with color coding and a hex cylinder shank with a snap ring next to the flat apical end. A narrow latch type fixture mount driver, which is designed for smaller dental implant and smaller DIMFA, consists of a narrow hex cylinder shank, a narrow snap ring and an extension bar, wherein the extension bar can have a metal to metal contact with the internal cavity of a dental implant to provide additional resistance against bending force during implant surgery so as to prevent dental implant from crack/fracture.

### BACKGROUND OF THE PRESENT INVENTION

1. Field of Invention

The present invention relates to (1) a dental implant fixture mount-abutment (DIFMA), particularly to the DIFMA having (a) a fixture mount which can be a short or long fixture mount, (b) an abutment with internal (triangular, square, pentagonal or hexagonal) slots for a fixture mount driver to place a dental implant and a DIFMA simultaneously, (c) a hex-shaped root to be harbored inside a hexamaximum/hexamaxim lock of a dental implant and (d) a ferro to engage a circumferential bevel of a dental implant, (2) a ball impression screw (BIS) for making an impression immediately after implant surgery, and (3) fixture mount drivers having a latch type end, driver shank and body to torque a DIFMA by inserting into the driven channel of the DIFMA during placement of a dental implant and a DIFMA into alveolar bone. Fixture mount drivers include a wide latch type fixture mount driver (2.5 mm in diameter) and a narrow latch type fixture mount driver (1.8 mm in diameter). An extension bar is designed on the apical end of a narrow latch type fixture mount driver to resist bending force arising out of implant surgery.

2. Description of Related Arts

Traditionally, a fixture mount (FM) has been used by most of dental implant systems to deliver and place dental implants. After the dental implant placed, the FM is removed from the dental implant and is discarded. Three to six months after the dental implant is placed, a conventional impression coping and copping screw are used for the purpose of making an impression to fabricate a stone cast for restoration which is not only a time consuming process but a waste of material due to discarding the FM.

Therefore, in order to provide a dental restoration, dentists have to pay the cost of the FM, impression copping/copping screw, preformed or custom abutment, which can be expensive, time consuming and clinically inconvenient.

The new design of the DIFMA is compelling because it can reduce cost, improve patient comfort and reduce clinical chair time/treatment time. The present invention which is a new design can be used as a FM, impression copping, provisional abutment and/or permanent abutment. In other word, a device can be used for four purposes. This new design includes a DIFMA, a BIS and a fixture mount driver.

The DIFMA can be used as a FM, impression copping, temporary and/or permanent abutment. The BIS can be placed on the top of the newly designed DIMFA to secure the DIFMA immediately after a dental implant is placed and impression can be made immediately after dental implant surgery without waiting period to facilitate an immediate loading of restoration. However, a long DIMFA does not require BIS for the purpose of impression. Patients can receive the benefits of chewing function and esthetics, immediately after the dental implant surgery, without a waiting period of three to six months.

### SUMMARY OF THE PRESENT INVENTION

A main object of the present invention is to provide a DIFMA which is cost effective and is less expensive.

Another object of the present invention is to provide a DIFMA which reduces time of treatment (chair time).

Another object of the present invention is to provide a DIFMA which reduces waiting period of treatment (three to six months).

Another object of the present invention is to provide a DIFMA which can improve clinical convenience. (It is difficult to seat impression copping immediately after the dental implant surgery due to bleeding)

Another object of the present invention is to provide a DIFMA which can reduce office visits.

Another object of the present invention is to provide a DIFMA which facilitates/speeds the process of immediate impression after implant surgery.

Another object of the present invention is to provide a DIFMA which facilitates/speeds the process of immediate loading for function and esthetic reasons.

Another object of the present invention is to provide a DIFMA which can increase patient comfort.

Another object of the present invention is to provide a BIS which provides additional surface for indentation/indexing can improves accuracy of impression.

Another object of the present invention is to provide a BIS which is cost effective and is less expensive.

Another object of the present invention is to provide a BIS which reduces time of treatment (chair time).

Another object of the present invention is to provide a BIS which can improve clinical convenience. (It is difficult to seat impression copping immediately after a dental implant surgery due to bleeding)

Another object of the present invention is to provide a BIS for making an impression immediately after the dental implant surgery.

Another object of the present invention is to provide two fixture mount drivers for torquing a DIMFA during implant surgery.

Another object of the present invention is to provide two fixture mount drivers including wide driver and narrow driver.

Accordingly, in order to accomplish the above objects, the present invention provides dental implant fixture mount-abutments, a ball impression screw and fixture mount drivers, comprising:

a fixture mount of a DIMFA serves as an impression coping;

two small flat facets of a fixture mount of a DIMFA for providing an anti-rotation feature;

a circumferential groove of a DIFMA;

an abutment of a DIMFA;

two large flat facets of the abutment for providing an anti-rotation feature;

a shoulder of a DIMFA;

a circumferential curvature of a DIMFA;

a ferro of a DIFMA for engaging with a bevel of a dental implant;

a hex-shaped root of a DIFMA for internally connecting to a dental implant;

an internal hexagonal (or triangular, square, pentagonal) slot of a DIMFA for receiving a hexagonal (or triangular, square, pentagonal) fixture mount driver;

a coronal head of a BIS;

a bolt of a BIS;

an apical end of a BIS for inserting into a DIFMA or a dental implant; securing the DIFMA or the dental implant;

a hex cylinder shank with a snap ring of a wide latch type fixture mount driver;

a hex cylinder shank, a snap ring and an extension bar of a wide latch type fixture mount driver;

a hex body consists of a round lower body with color coding and a upper hexagonal body of both latch type fixture mount drivers;

a shank (cylinder body) of both wide latch type fixture mount driver and short latch type fixture mount driver;

a latch type end of both wide latch type fixture mount driver and short latch type fixture mount driver;

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a dental implant fixture mount-abutment (DIFMA) according to a preferred embodiment of the present invention.

FIG. 2 is an exploded view illustrating a dental implant, a DIFMA, a bolt and a fixture mount driver for securing the DIMFA with the dental implant according to above preferred embodiment of the present invention.

FIG. 3 is a sectional view of a DIFMA according to above preferred embodiment of the present invention.

FIG. 4 is a perspective view of an alternative version of a DIFMA according to above preferred embodiment of the present invention.

FIG. 5 is a sectional view of the alternative version of a DIFMA according to above preferred embodiment of the present invention.

FIG. 6 is a perspective view of a ball impression screw (BIS) according to above preferred embodiment of the present invention.

FIG. 7 is an exploded view illustrating a dental implant, a DIFMA and a BIS for securing the DIMFA with the dental implant according to above preferred embodiment of the present invention.

FIG. 8 is a connected view illustrating a dental implant, a DIFMA and a BIS for securing the DIMFA with the dental implant according to above preferred embodiment of the present invention.

FIG. 9 is a sectional view of a BIS according to above preferred embodiment of the present invention.

FIG. 10 is a perspective view of an alternative mode of a BIS according to above preferred embodiment of the present invention.

FIG. 11 is a perspective view of an alternative version of a DIFMA according to the above preferred embodiment of the present invention.

FIG. 12 is a sectional view of the alternative version of a DIFMA according to above preferred embodiment of the present invention.

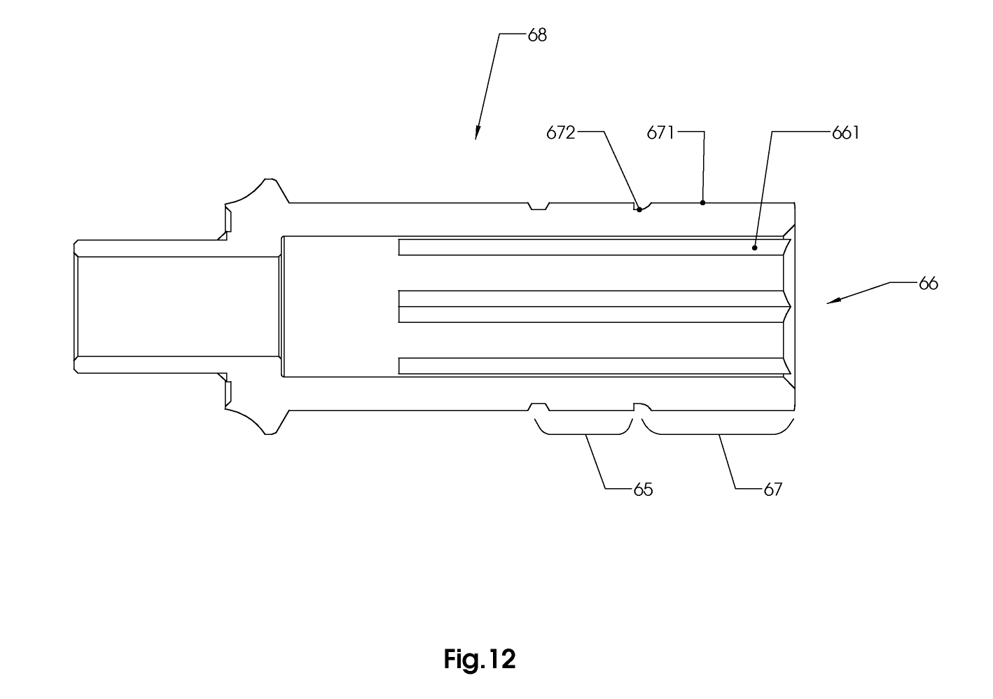

FIG. 13 is a perspective view of both wide and narrow latch type fixture mount driver according to the above preferred embodiment of the present invention.

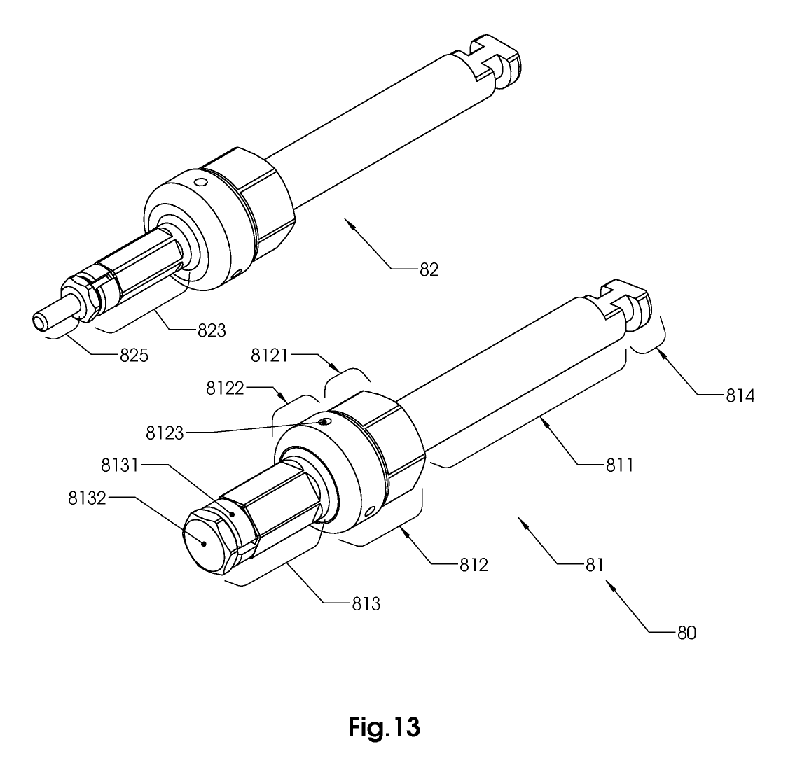

### DETAILED DESCRIPTION OF THE PREFERRED EMBODIMENT

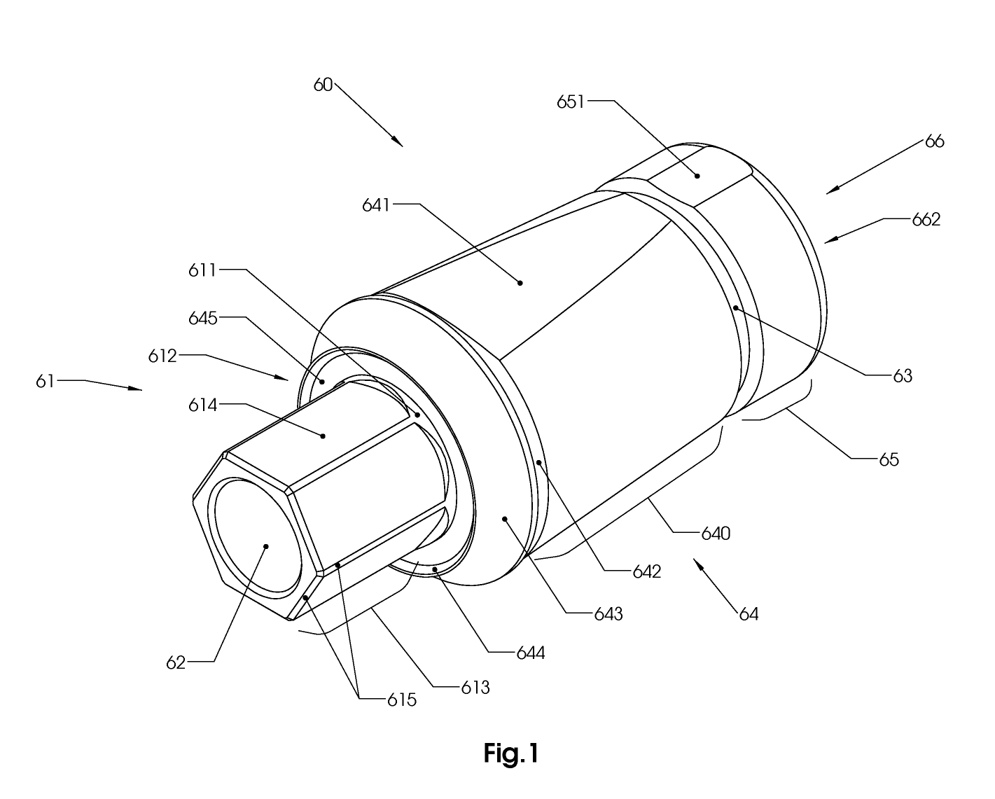

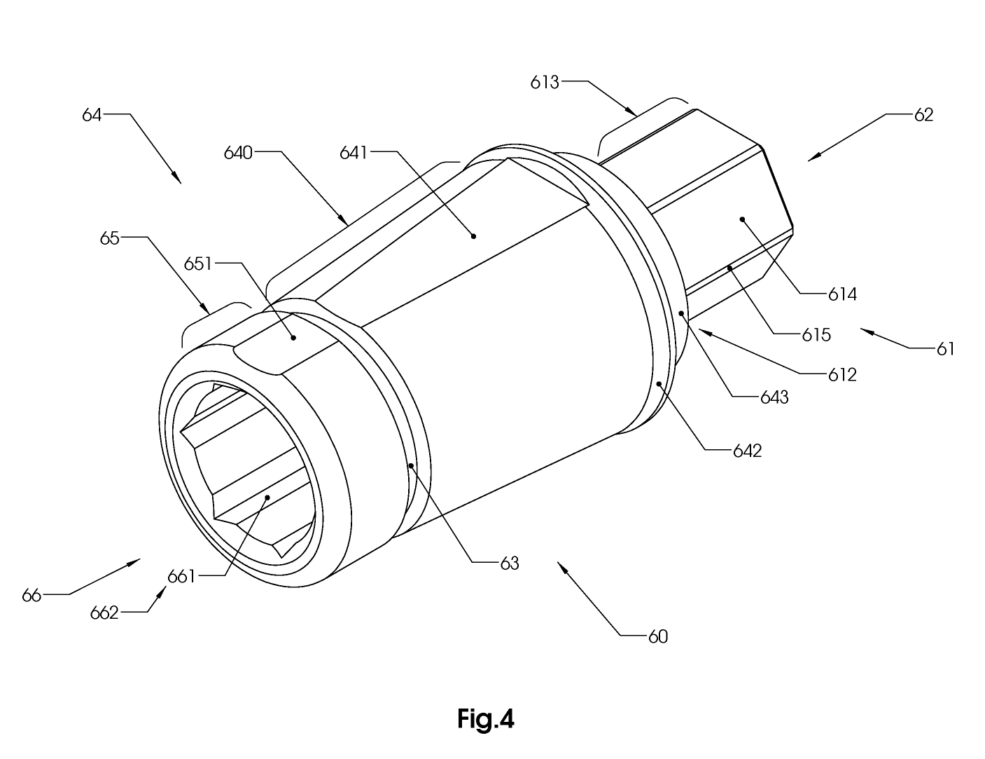

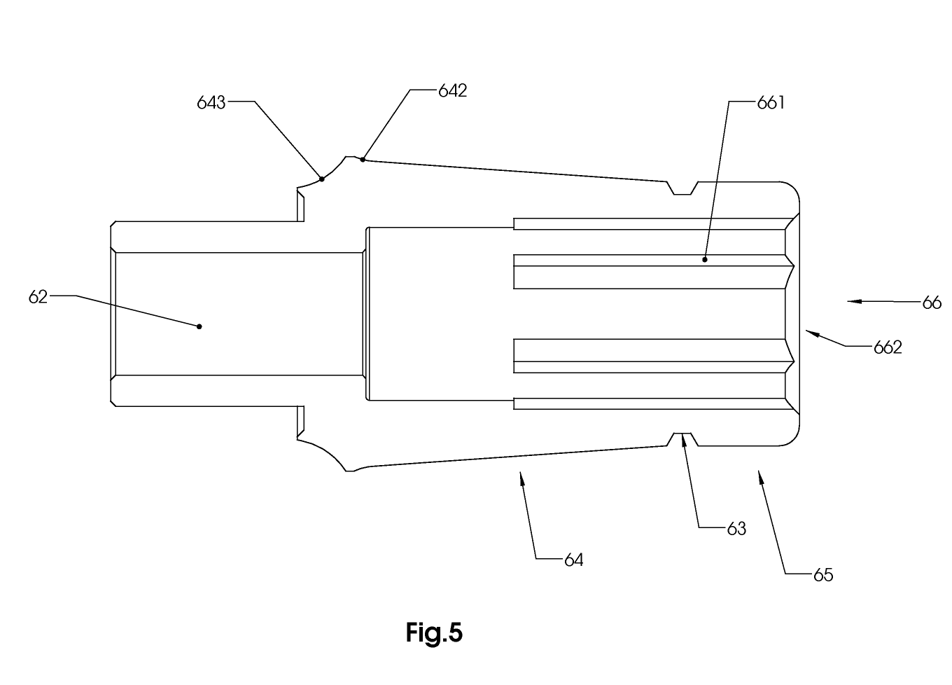

Referring to FIGS. 1 to 5 of the drawings, a dental implant fixture mount-abutment (DIFMA) 60 according to a preferred embodiment of the present invention is illustrated, wherein the DIFMA 60 comprises a fixture mount 65, which is a metal collar at a coronal end 66 for receiving a fixture mount driver 80, and an abutment 64, which is a tapered cylinder body 640, and a hex-shaped root 61, which is a hex-shaped body 613, for internally connecting to a dental implant 10 through a bolt 70. The bolt 70 is used to secure a DIFMA 60 and a dental implant 10 before using a fixture mount driver 80.

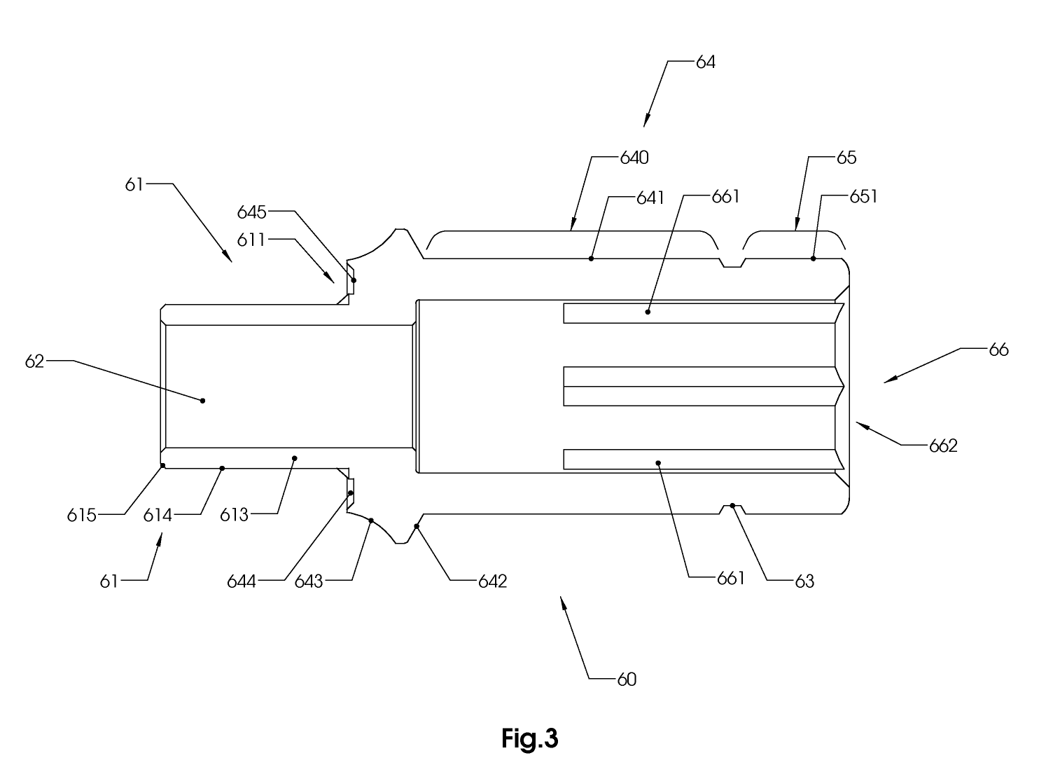

The fixture mount 65 is a 2 to 4 mm coronal extension/metal collar delineated from the abutment portion 64 separated by a circumferential groove 63. The fixture mount 65 is designed to extend the DIFMA 60 with the addition of a ball impression screw (BIS) 90 to serve as an impression coping for closed tray technique. The abutment 64 can be used as a temporary abutment after the fixture mount 65 is removed by a lab disk. The circumferential groove 63 is also designed to serve as an impression coping retentive feature. As illustrated in the cross sectional view of FIG. 3, a driven channel 662 of the coronal end 66 of the DIFMA 60 is designed to receive a fixture mount driver 80.

The fixture mount 65 has two small flat facets 651, located on opposite sides of the fixture mount 65, extending between the coronal end 66 and the circumferential groove 63. The abutment 64 has a tapered cylinder body 640 with two large flat facets 641, located on opposite sides of the abutment 64, extending between the circumferential groove 63 and the shoulder 642. The small flat facets 651 and the large flat facets 641 enable the DIFMA 60 to provide an anti-rotation feature for crown restoration.

Referring to FIGS. 1 to 3, the DIFMA 60 has a shoulder 642 on the abutment portion 64. The shoulder 642 is designed to seat the margin of a crown restoration. A circumferential curvature 643 apically located to the shoulder 642 is designed to avoid engaging alveolar bone so as to be easily removed later.

Referring to FIGS. 1 to 3, the hex-shaped root 61 of the DIFMA 60 is a male connector for internally connecting to a dental implant 10. The hex-shaped root 61 is designed to be inserted into a dental implant 10 and the hex-shaped root 61 fits a hexamaxim/hexamaximum lock 40 of the dental implant 10. The diameter of the abutment 64 and the hex-shaped root 61 varies according to different sizes of the dental implant 10.

It is worth mentioning that the conventional abutment generally has only three engaging jaws for engaging with three internal engaging portion of the conventional dental implant, wherein the abutment has to be rotated 120° to get to the next secure position and there are only three secured positions to choose from. This is very inconvenient to place the abutment with a suitable rotary angle especially when the root of the abutment has an angle. According to FIGS. 1 to 4, the hex-shaped root of the DIFMA 60 consists of 6 flat vertical surfaces to engage a hex-shaped hexamaxim/hexamaximum lock 40 of a dental implant 10. So that the angle is 60° rotating from one engaging position to the next engaging position and the DIMFA 60 has six secured positions to choose from while the prior art abutment merely contains three secured positions to choose from. In other words, the conventional abutment needs to be rotated 120° to find the next secured position and the DIFMA 60 of the present invention enables the dentist to simply rotate it for 60° for the next secured position. It is much flexible to find a suitable rotary angle for easy alignment of a dental crown.

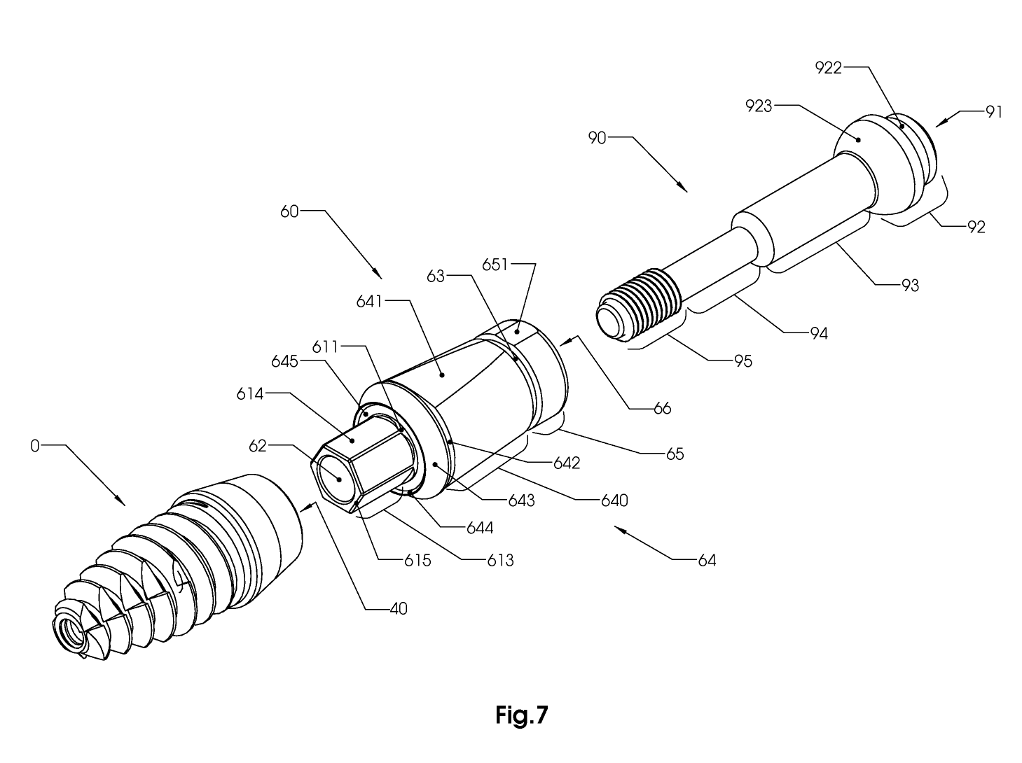

Referring to FIGS. 1 to 5 and 7, the ferro 644 is a circumferentially inclined surface to engage the circumferential bevel of a dental implant 10, and the 6 wave-shaped protruding features 611 are designed to engage the hexamaxim/hexamaximum lock 40 of dental implant 10. These two additional retentive features together can dramatically enhance the stabilization between a DIMFA 60 and a dental implant 10.

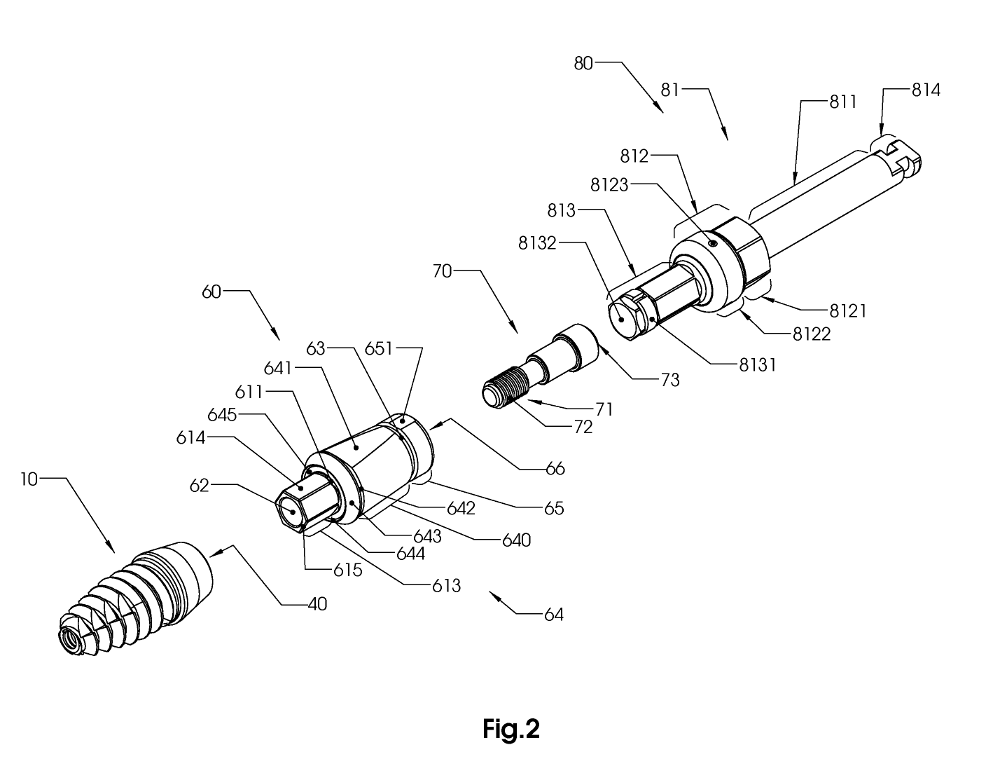

Referring to FIG. 2, the DIFMA 60 is fastened onto the dental implant 10 through the bolt 70. The DIFMA 60 has a through hole 62 communicating the hexamaxim/hexamaximum lock 40 of the dental implant 10.

Referring to FIG. 2, the tip 71 of the bolt 70 having an external thread 72 is adapted to pass through the through hole 62 of the DIFMA 60 and the hexamaxim/hexamaximum lock 40 of the dental implant 10. The head 73 of the bolt 70 remains in the through hole 62 of the DIFMA 60 for driving the bolt 70 and retaining the abutment 64. In this manner, the bolt 70 and the dental implant 10 have a metal to metal contact which is very stable. This can steadily fasten the DIMFA 60 onto the dental implant 10. The stability is largely increased.

Referring to FIGS. 3 to 5 & 13 of the drawings, an internal hexagonal (triangular, square or pentagonal) slot 661 located at the internal wall of a DIFMA 60 is designed to receive a hexagonal (triangular, square or pentagonal) fixture mount driver 80. The length of the slots 661 can range from 4 mm to 8 mm.

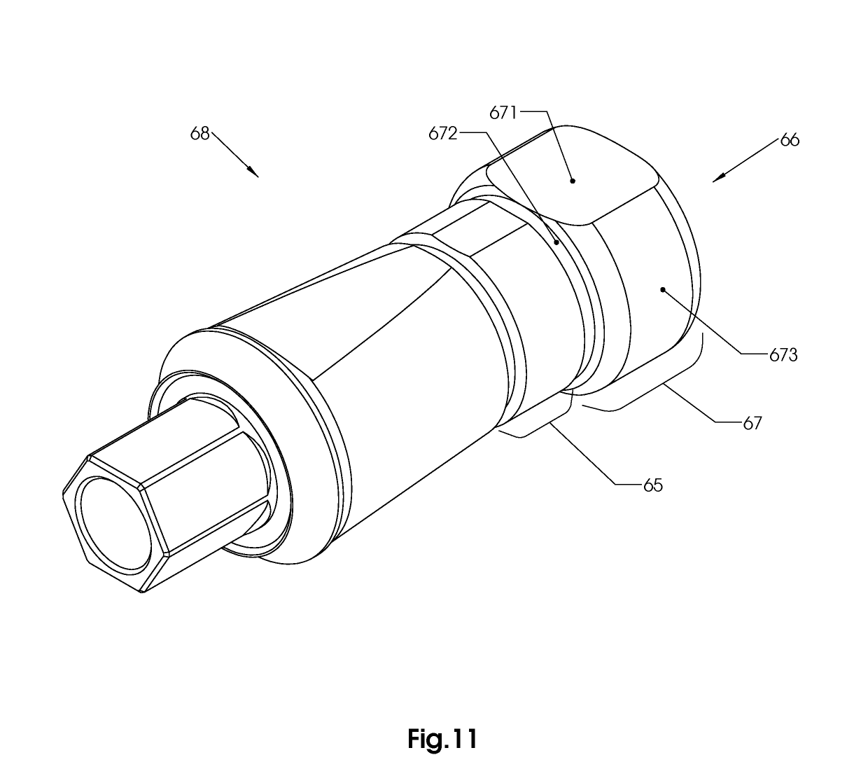

Referring to FIGS. 11 & 12, a long DIMFA 68, which is an alternative version of a DIMFA 60, is illustrated, wherein a long DIMFA 68 consists of an additional extension portion 67 which is a cylinder shape shank extends 3 mm˜4 mm out of the fixture mount 65. The extension portion 67 includes two flat surfaces 671 located at opposite sides of the extension portion 67, two semi-circular surfaces 673 and a circumferential indentation 672 located coronally to the fixture mount 65. The flat surfaces 671 enable a long DIMFA 68 to have additional resistance against rotation and have better indexing for making an impression.

Referring to FIGS. 2 & 13, the fixture mount drivers 80, which include a wide latch type fixture mount driver 81 and a narrow latch type fixture mount driver 82, are illustrated. The wide latch type fixture mount driver 81 comprises a shank 811, which is a cylinder body, a latch type end 814, for adapting to a slow speed handpiece, a hex body 812, having a upper hexagonal body 8121 and a round lower body 8122 with color coding 8123, a hex cylinder shank 813 with a plastic snap ring 8131 on the end to carry DIFMA 60 and to place a dental implant 10, and a flat apical end 8132 on the apical end of the fixture mount driver 80. Comparing to the wide latch type fixture mount driver 81, the narrow latch type fixture mount driver 82 has a narrow hex cylinder shank 823 which is designed for small-size dental implant, and an extension bar 825 which prevent the dental implant from being damaged by bending force during implant surgery.

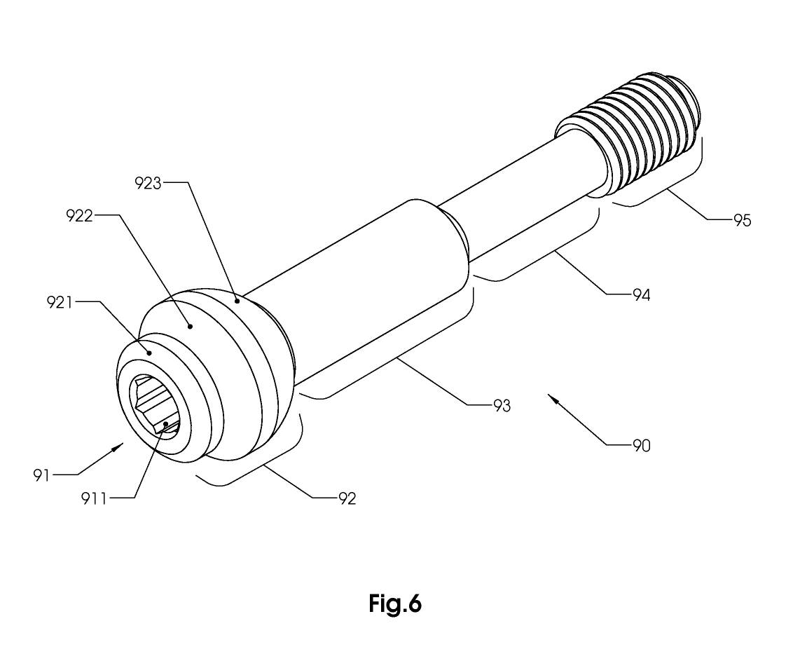

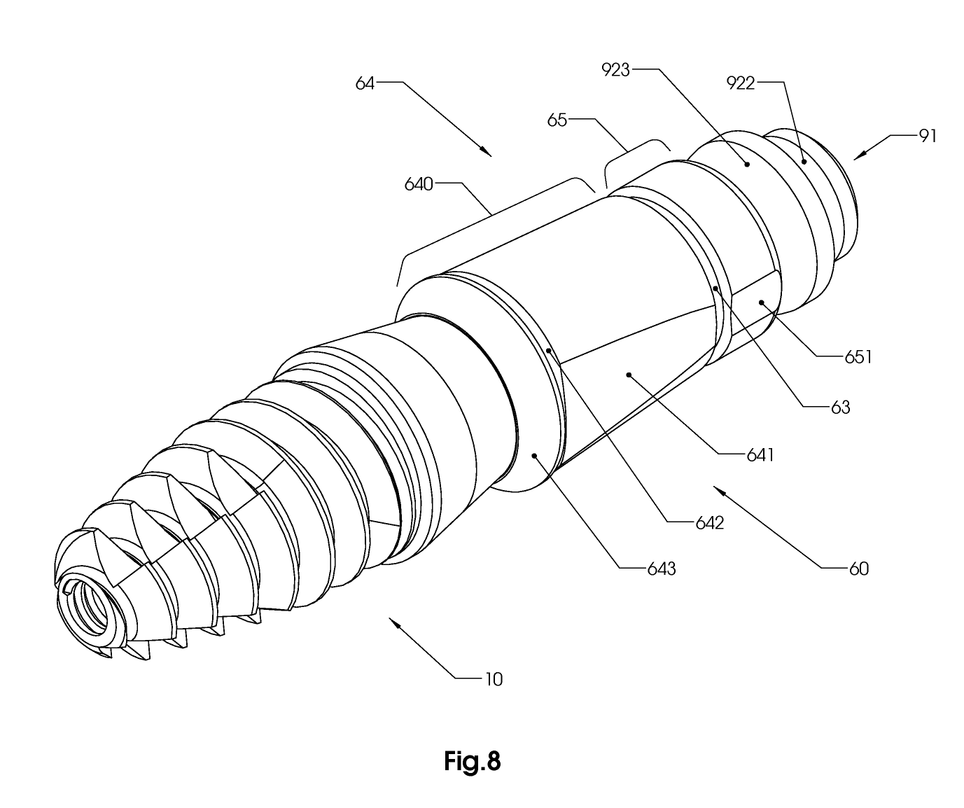

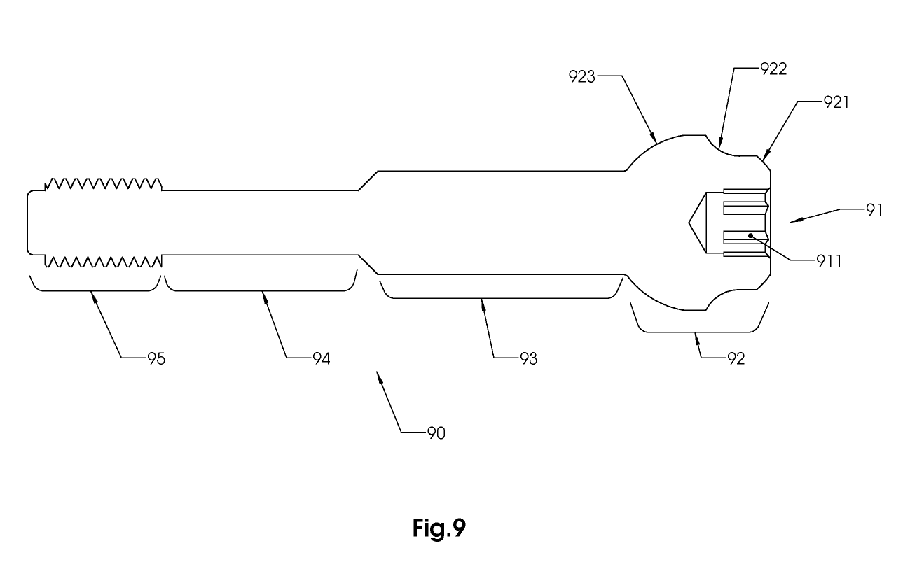

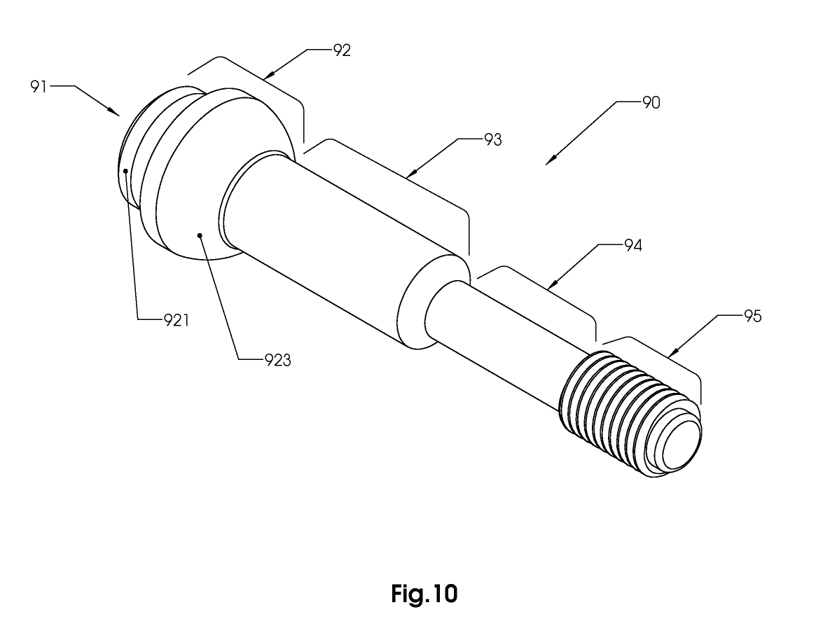

Referring to FIGS. 6 to 10 of the drawings, the ball impression screw (BIS) 90, according to a preferred embodiment of the present invention, is illustrated, wherein the BIS 90 comprises a dental implant ball impression screw bolt 94, which is a cylinder body, having the apical end 95 for inserting through a DIFMA 60 into a dental implant 10 and a dental implant ball impression screw shank 93, which is a cylinder body, having the coronal head 92 for providing additional retentive feature for a DIFMA 60 to serve as an impression coping.

After a dental implant 10 is placed, the fixture mount driver 80 and the bolt 70 used to fasten a DIFMA 60 onto a dental implant 10 are removed. Then, the BIS 90 is used to connect and fasten a DIFMA 60 onto a dental implant 10. A coronal head 92 of the BIS 90 remains outside of the driven channel 662 of a DIFMA 60.

Referring to FIGS. 6 to 9, the coronal head 92 of the shank 93 comprises a large hemisphere 923, a circumferential notch 922, a small hemisphere head 921 and a hexagonal concavity 91. The connection between the large hemisphere 923 and the fixture mount 65 will form a circumferential groove 63 to serve as an impression coping retentive feature. An internal hexagonal (or triangular, square, pentagonal) slot 911 of the hexagonal concavity 91 is made to receive a hexagonal (or triangular, square, pentagonal) fixture mount driver 80.

Referring to FIGS. 11 & 12, however, it is worth mentioning that a long DIMFA 68, because that the extension portion 67 gives enough indentation impression, does not require to have a BIS 90 for impression.

In summary, a DIFMA 60 specifically designed for the purpose of immediate implant placement and immediate impression was proposed. The new design employs several modern concepts in order not only to enhance the primary stability but also to provide multiple applications of an implant fixture mount. Utilizing a new designed DIFMA 60 coupled with a BIS 90 or utilizing a long DIMFA 68 without a BIS 90, the clinician can take an immediate final impression right after implant placement. A cast can then be immediately poured for wax up and a screw-retained/cement-retained provisional prosthesis is fabricated and delivered within the same day. A definitive prosthesis can be fabricated and delivered in a couple of days. Alternatively, an acrylic shell can be fabricated before the surgery and a provisional prosthesis can be fabricated and placed on a modified DIFMA 60 to be used as a temporary abutment at chair side right after the dental implant placement. A DIFMA 60 can also be modified and used as a permanent abutment.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A dental implant fixture mount-abutment (DIFMA), comprising a fixture mount which is a 2 to 4 mm coronal extension/metal collar at a coronal end for serving as an impression coping, temporary/permanent abutment and fixture mount, wherein an internal slot in said coronal end for receiving a fixture mount driver, wherein a driven channel in said coronal end for receiving a ball impression screw, wherein said fixture mount has two small flat facets, located on opposite sides of a fixture mount, extended between said coronal end and a circumferential groove, an abutment which is a taper cylinder body having a shoulder and a circumferential curvature, wherein said shoulder on the abutment portion is a part of said abutment, wherein said circumferential curvature is designed to avoid engaging alveolar bone so as to be easily removed later, wherein said abutment has two large flat facets, located on opposite sides of said abutment, extended between said circumferential groove and shoulder, providing an anti-rotation feature, wherein a ferro is a circumferentially inclined surface to engage a circumferential bevel of a dental implant, increasing the stabilization between a DIFMA and a dental implant, wherein 6 wave-shaped protruding features, which are designed to engage a hexamaxim/hexamaximum lock, provide additional retention, wherein a hex-shaped root of a DIFMA is a male connector for internally connecting to a dental implant. A long DIMFA is an alternative version which contains an extension portion adjacent to said fixture mount. It has two flat surfaces, two semi-circular surfaces and a circumferential indentation, extending between said coronal end and said fixture mount.

2. The DIFMA, as recited in claim 1, wherein said fixture mount is a 2 to 4 mm coronal extension/metal collar at a coronal end for serving as an impression coping, temporary/permanent abutment and fixture mount.

3. The DIFMA, as recited in claim 1, wherein said fixture mount is designed to extend the DIFMA, serving as an impression coping.

4. The DIFMA, as recited in claim 1, wherein said internal hexagonal (or triangular, square, pentagonal) slots vary from 4 mm to 8 mm in length, of the present invention is made to receive a hexagonal (or triangular, square, pentagonal) fixture mount driver.

5. The DIFMA, as recited in claim 1, wherein said two small flat facets, located on opposite sides of said fixture mount, are extending between said coronal end and said circumferential groove. The two flat facets provide an anti-rotation feature.

6. The DIFMA, as recited in claim 1, wherein said abutment is a tapered cylinder body having a shoulder and a circumferential curvature.

7. The DIFMA, as recited in claim 1, wherein said abutment is designed for closed tray impression technique with the addition of a ball impression screw.

8. The DIFMA, as recited in claim 1, wherein said abutment can be used as a temporary abutment after said fixture mount is removed by a lab disk.

9. The DIFMA, as recited in claim 1, wherein said two large flat facets, located on opposite sides of said abutment, are extending between said circumferential groove and said shoulder. The two large flat facets provide an anti-rotation feature.

10. The DIFMA, as recited in claim 1, wherein said shoulder on said abutment is made for seating a crown restoration.

11. The DIFMA, as recited in claim 1, wherein said circumferential curvature is designed to avoid engaging alveolar bone so as to be easily removed later.

12. The DIMFA, as recited in claim 1, wherein said ferro is a circumferentially inclined surface designed to engage circumferential bevel of dental implant, providing additional retention and resistance form.

13. The DIMFA, as recited in claim 1, wherein said 6 wave-shaped protruding features are designed to engage a hexamaxim/hexamaximum lock of a dental implant to provide additional retention.

14. The DIFMA, as recited in claim 1, wherein said hex-shaped root is a male connector for internally connecting to said dental implant.

15. The DIFMA, as recited in claim 1, wherein said hex-shaped root is designed to be inserted into a dental implant and the dimension of said hex-shaped root passively fits to the internal channel of said dental implant.

16. The long DIMFA, as recited in claim 1, wherein said extension portion which extends 3 mm˜4 mm from said fixture mount, includes two flat surfaces, two semi-circular surfaces and a circumferential indentation, providing additional anti-rotation feature for making an impression.

17. A dental implant ball impression screw (BIS), comprising a bolt which is a cylinder body having an apical end, wherein said apical end of said bolt is designed to insert through a DIFMA into a dental implant, said bolt and said dental implant have a metal to metal contact which is very stable, and a shank which is a cylinder body having a coronal head, wherein said coronal head of said shank comprises a large hemisphere, a circumferential notch, a small hemisphere head and a hexagonal concavity.

18. The BIS, as recited in claim 17, wherein said shank which is a cylinder body having a coronal head for the DIFMA to serve as an impression coping.

19. The BIS, as recited in claim 17, wherein said apical end of this bolt is designed to insert through a DIFMA into a dental implant. In this manner, this bolt and the dental implant have a metal to metal contact which is very stable.

20. The BIS, as recited in claim 17, wherein said coronal head provides additional retentive feature for a DIFMA to serve as an impression coping.

21. The BIS, as recited in claim 17, wherein said coronal head of the shank comprises a large hemisphere, a circumferential groove and a small hemisphere. The connection between the large hemisphere and the fixture mount will form a circumferential notch to serve as an impression coping retentive feature.

22. A wide latch type fixture mount driver, comprising a shank which is a cylinder body having a latch type end, a body which has a upper hexagonal body and a round lower body with color coding and a hex cylinder shank with a snap ring next to a flat apical end. A narrow latch type fixture mount driver, which is designed for smaller dental implant and smaller DIMFA, consists of a narrow hex cylinder shank, a narrow snap ring and an extension bar, wherein said extension bar can have a metal to metal contact with a internal cavity of said dental implant to provide additional resistance against bending force during implant surgery so as to prevent dental implant from crack/fracture.

23. The wide latch type fixture mount driver, as recited in claim 22, wherein said hex cylinder shank is designed to loosely fit said driven channel of said DIMFA as recited in claim 1.

24. The wide latch type fixture mount driver, as recited in claim 22, wherein said snap ring next to said flat apical end of said hex cylinder shank to carry a DIFMA and driving a dental implant during implant surgery.

25. The wide latch type fixture mount driver and the narrow latch type fixture mount driver, as recited in claim 22, wherein said shank, which is a cylinder body, has a latch type end for adapting to a slow speed handpiece.

26. The narrow fixture mount driver, as recited in claim 22, contains a narrow hex cylinder shank, a narrow snap ring and an extension bar for driving said smaller dental implant and said smaller DIMFA.

27. The narrow latch type fixture mount driver, as recited in claim 22, wherein said narrow hex cylinder shank is designed to loosely fit a driven channel of said smaller DIMFA.

28. The narrow latch type fixture mount driver, as recited in claim 22, wherein said narrow snap ring is placed at the bottom portion of said hex cylinder shank to carry a DIFMA and driving a dental implant during implant surgery.

29. The narrow fixture mount driver, as recited in claim 22, wherein said extension bar can have a metal to metal contact with a internal cavity of said smaller dental implant to provide additional resistance against bending force during implant surgery.
